(19) United States
(12) Patent Application Publication
(10) Pub. No.: US 2002/0023611 A1
(43) Pub. Date: Feb. 28, 2002

(54) Metal products having integrally formed seals

(76) Inventors: Kouichi Hara, Obu (JP); Kiyofumi Kumagai, Obu (JP); Kazuo Hirasawa, Obu (JP)

Correspondence Address: DENNISON, SCHEINER SCHULTZ & WAKEMAN, 612 CRYSTAL SQUARE FOUR, 1745 JEFFERSON DAVIS HIGHWAY, ARLINGTON, VA, 22202-3417, US

(21) Appl. No.: 09/806,226

(22) Filed: Mar. 27, 2001

Related U.S. Application Data
(63) Continuation-in-part of application No. PCT/JP00/04925, filed on Jul. 21, 2000.

(30) Foreign Application Priority Data
Jul. 22, 1999 (JP) 11-206957

(51) Int. Cl. B23P 17/00

(52) U.S. Cl. 123/195 C; 29/527.5; 29/527.3; 277/627

(57) ABSTRACT

Metal products are taught that comprise integrally formed resin seals. The fastening strength of a rubber or synthetic resin seal is increased because the resin seal is formed during a casting operation. For example, an unvulcanized rubber or unhardened resin seal member (9′) may be temporarily secured to a metal mold (A₁) and heat from the molten metal vulcanizes or hardens the seal member (9′), thereby integrally forming a rubber or synthetic resin seal and a metal molded body. Resin seals can be integrally formed on metal products having a variety of shapes, because the resin seal will melt and integrally form with the metal product during the die casting operation. That is, the resin seal is adhered to the metal product by a diffusion or seamless bond. In one representative embodiment, an engine head cover is die cast and a plurality of bolts protrude from the engine head cover. Resin seals are integrally formed on the outer surface of the engine head cover at each boundary in which a bolt contacts the engine head cover.

### CROSS-REFERENCE

This application is a continuation-in-part of PCT application serial no. PCT/JP00/04925 filed Jul. 21, 2000, which PCT application designates the United States of America and claims priority to Japanese patent application serial no. 11-206957 filed Jul. 22, 1999. PCT application serial no. PCT/JP00/04925 and Japanese patent application serial no. 11-206957 are both hereby incorporated by reference in their entirety.

### BACKGROUND OF THE INVENTION

1. Technical Field

The present teachings relate to metal molded products that are formed by die casting or thixocasting a molten metal. More particularly, the metal molded products preferably include an integrally formed seal that comprises a resin material. Methods for making such metal molded products and molds for making such metal molded products are also described.

2. Description of the Related Art

As shown in FIG. 29, engine head covers, gearbox covers, etc., may include a threaded metal bolt B that is inserted into molded body 16 in order to form an integrated product. Metal bolt B may consist of a different metal composition than molded body 16. The integrated product may be formed, for example, by setting metal bolt B inside a metal mold and then injecting molten magnesium alloy around metal bolt B. Magnesium is the lightest of the light metals (having a specific gravity of 1.74) and is characterized by the advantages of high strength and rigidity per unit weight. However, among general-purpose metals, magnesium is the most inferior in terms of electrochemical characteristics. If a liquid electrolyte, such as water droplet W, is present at the boundary of the two different metals (i.e. the boundary between molded body 16 and bolt B as shown in FIG. 29), magnesium carbonate and magnesium hydroxide are likely to form at the boundary, due to the difference in potential between the two metals. Thus, severe oxidation problems at the boundary surface may result and the integrated product may be subject to premature corrosion.

As shown in FIG. 30, one known technique for avoiding this premature corrosion problem involves installing a gasket 52 between molded body 16 and corresponding part 51. Bolt B is partially inserted into molded body 16 and engages nut 53. However, even in this known technique, a gap remains between hole 54 and bolt B. Consequently, water droplet W can adhere to the boundary surface of the different metals by entering through the gap. Thus; even though gasket 52 is provided, oxidation at the boundary surface between molded body 16 and bolt B can not be prevented.

In addition, various methods are known for installing a waterproof seal 62, such as an O-ring or a gasket, along the opening edge of a square case 61, as shown in FIG. 31. For example, as shown in FIG. 32, a separately formed seal 62 may be adhered using a glue, or adhesive tape, etc. As shown in FIG. 33, the bottom half of a separately formed seal 63 may be press-fitted into a press-fitting groove 64 provided on the opening edge of case 61. Further, as shown in FIG. 34, a seal 65 may be formed by applying a caulk to the opening edge of case 61.

When the opening edge is flat, such as square case 61, seals 62, 63, and 65 can be installed along the opening edge using such known methods. However, if the opening edge is three-dimensionally curved, as shown in case 66 of FIG. 35, it is difficult to install the seal 67 to a specified strength using any of the known methods. Furthermore, it is also difficult to reliably install a seal on the internal surface of a cylinder.

### SUMMARY OF THE INVENTION

It is, accordingly, an object of the present teachings to overcome one or more problems of the known art.

In one aspect of the present teachings, a seal is integrally formed with a metal product. As a result, the fastening strength of the seal to the metal product can be substantially increased. This seal may be integrally formed, for example, by placing a rubber or synthetic resin seal in a mold and then injecting the molten metal into the mold. The seal will partially melt and combine with the metal to form a tight bond between the metal and the seal. The integrally formed seal may be formed by die casting or thixocasting methods.

In another aspect of the present teachings, methods are taught for making a metal molded product having an integrally formed rubber or synthetic resin seal. Preferably, an unvulcanized rubber or unhardened resin seal member is temporarily secured to a metal mold. Thereafter, molten metal is injected into the metal mold and heat from the molten metal vulcanizes or hardens the seal member, thereby integrally combining the rubber or synthetic resin seal and the metal molded body. In this aspect, the rubber or synthetic resin seal is integrally formed with the metal molded body during die cast molding of the metal molded product. Thus, the seal can be integrally formed with the metal molded body regardless of the shape of the seal itself or the position at which the seal will be installed on the metal molded body. Consequently, a tight, secure bond can be formed between the seal and the metal product.

In another aspect of the present teachings, methods are taught for making a metal molded product that comprises a metal part having a different metal composition. Preferably, an integrally formed seal is disposed at the boundary of the two metals so as to protect the final metal product from premature corrosion at the boundary of the different metal compositions. In this aspect, the metal part may be first inserted into the metal mold and the unvulcanized rubber or unhardened resin seal member is temporarily secured to the expected boundary surface between the metal part and the metal molded body. Again, molten metal may be injected into the metal mold and heat from the molten metal will vulcanize or harden the seal. Thus, an integrally formed rubber or synthetic resin seal is disposed between the metal molded body and the metal part having a different composition from the metal molded body.

As a result, liquid electrolytes are prevented from reaching the boundary between the two different metals and corrosion at the boundary surface can be significantly reduced or eliminated. Furthermore, because the rubber or synthetic resin seal is integrally formed during the molding process of the metal molded product, a separate process for forming the seal is not needed.

In another aspect of the present teachings, a pressure wall is disposed on the molding surface of the metal mold proximally to a groove that is adapted to temporarily retain the resin seal member. The pressure wall prevents the injection pressure of the molten metal from being directly applied to the unvulcanized rubber or unhardened resin seal member that is temporarily secured to the metal mold during die cast molding or thixocasting of the metal molded body. Therefore, the unvulcanized rubber or unhardened resin seal member is not drawn into the molten metal during the molding operation and the seal member is vulcanized or hardened in the correct position. As a result, the seal member is reliably formed at the boundary surface between the metal molded body and the metal part.

These aspects and features may be utilized singularly or in combination in order to make improved metal molded products having integrally formed seals. In addition, other objects, features and advantages of the present teachings will be readily understood after reading the following detailed description together with the accompanying drawings and the claims. Of course, the additional features and aspects disclosed herein also may be utilized singularly or in combination with the above-described aspects and features.

### BRIEF EXPLANATION OF THE DRAWINGS

FIG. 1 is a broken apart, perspective view showing metal mold A for forming a head cover F₁.

FIG. 2 is a vertical cross-sectional diagram of metal mold A of FIG. 1 in the molding state.

FIG. 3 is a perspective drawing of bolt B having a seal member 9′, which comprises unvulcanized EPDM, wound around stem 4.

FIG. 4 is a magnified view showing bolt B, on which the seal member 9′ is wound, before insertion into bolt stem insertion hole 5 of convex mold A₁.

FIG. 5 is a cross-sectional diagram showing the flow of a molten magnesium alloy M inside molding space C between molds A₁ and A₂.

FIG. 6 is a cross-sectional diagram showing the state in which the molten magnesium alloy M has filled molding space C between molds A₁ and A₂.

FIG. 7 is a perspective drawing of head cover F₁ formed using a method according to the present teachings.

FIG. 8 is a cross-sectional diagram of bolt B within the head cover F₁.

FIG. 9 is a perspective drawing showing a broken away view of the metal molds A₁ for forming a head cover F₂.

FIG. 10 is a cross-sectional perspective drawing (along line X-X in FIG. 9) of convex mold A₁′.

FIG. 11 is a partially magnified cross-sectional diagram showing the state in which seal 22′ is temporarily secured within groove 23 of convex mold A₁′.

FIG. 12 is a magnified cross-sectional diagram of seal 22′ at the start of molding.

FIG. 13 is a magnified cross-sectional diagram of seal 22′ at the finish of molding.

FIG. 14 is a perspective drawing of case F₂having seal 22 that is integrally formed on an opening edge.

FIG. 15 is a perspective drawing of case F₃ having seal 24 that is integrally formed on an opening edge.

FIG. 16 is a perspective drawing of cylindrical molded product F₄ having rubber cushion 26 that is integrally formed in the interior.

FIG. 17 is a vertical cross section of cylindrical molded product F₄ as shown in FIG. 16.

FIG. 18 is a perspective drawing of elbow-shaped molded product F₅ having rubber seal 29 that is integrally formed in the interior.

FIG. 19 is a vertical cross section of elbow-shaped molded product F₅ as shown in FIG. 18.

FIG. 20 is a perspective drawing of barbell-shaped molded product F₆, in which rubber cushion 32 is integrally formed on the inside of platter 31.

FIG. 21 is a vertical cross section of barbell-shaped molded product F₆ as shown in FIG. 20.

FIG. 22 is a perspective drawing of cylindrical molded product F₇ having thick-walled cylindrical cushion 35 that is integrally formed on its interior.

FIG. 23 is a vertical cross section of cylindrical molded product F₇ as shown in FIG. 22.

FIG. 24 is a cross-sectional diagram of metal mold A″ before a glass plate 41 is temporarily secured, which glass plate 41 has ring-shaped seal 42′ that is press-fitted on its exterior edge.

FIG. 25 is a cross-sectional diagram of metal mold A″ after glass plate 41 has been temporarily secured.

FIG. 26 is a partially magnified view of FIG. 25.

FIG. 27 is a perspective drawing of glass-integrated molded product F₈.

FIG. 28 is a cross-sectional drawing (along line Y-Y in FIG. 27) of the center area of the FIG. 27.

FIG. 29 is a cross-sectional drawing of a bolt B of a metal molded product (head cover F₁′) molded using a known method.

FIG. 30 is a cross-sectional drawing showing a structure having a packing 52 that prevents oxidation of the boundary surface between molded body 16 and bolt B.

FIG. 31 is a perspective drawing showing the state in which case 61 and an unattached seal 62 are broken away.

FIG. 32 is a partially magnified cross-sectional diagram showing the state in which seal 62 is glued to the opening edge of case 61.

FIG. 33 is a partially magnified cross-sectional diagram showing the state in which the bottom half of seal 63 has been press-fitted into press-fitting groove 64 on the opening edge of case 61.

FIG. 34 is a partially magnified cross-sectional diagram showing the state in which seal 65 has been installed by applying caulking to the opening edge of case 61.

FIG. 35 is a perspective drawing showing the state in which a case 66 having a three-dimensionally curved opening edge and seal 67 to be installed on this opening edge are broken away.

### DETAILED DESCRIPTION OF THE INVENTION

Metal molded products are taught that are preferably formed by die casting or thixocasting a molten metal. Preferably, a rubber or synthetic resin seal forms a diffusion or a seamless bond with the metal molded product due to the resin seal melting and commingling with the molten metal during the molding process. Although not wishing to be bound by theory, the diffusion bond between the metal and the seal according to the present teachings is believed to involve an intermixing of the metal and the resin material. Thus, the bond between the metal and the seal gradually changes from a composition that is purely metal to a composition that is purely resin. Naturally, at some point in the diffusion bond, the composition is likely to be an equal mixture of resin and metal. In some cases, the diffusion bond may contain a portion comprises a composition that is primarily metal with some resin molecules interspersed within the metal and another portion comprising a composition that is primarily resin molecules with some metal interspersed within the resin.

Accordingly, the present teachings relate to “diffusion bonds” between the resin material and the metal product. In this specification, “diffusion bond” means a joining technique in which two surfaces are contacted under high pressure and/or temperature and as a result, the atoms from one component diffuse into the atoms of the other component, thereby filling voids between the two components and producing an integral bond.

The bond between the resin seal and the metal molded product may also be characterized as a “seamless” bond, because the resin seal and the metal molded product are adhered to each other without any clear border or boundary between the two materials. Thus, the seamless bond is characterized by a gradual changing of the material from metal to resin along a transverse direction. Further, some of the metal is believed to penetrate or permeate into the resin material along a plurality of channels, and vice versa. Preferably, no voids or air packets remain between the resin seal and the metal. Also, while an adhesive may be utilized with a diffusion or seamless bond, it is also possible to directly contact the resin member and the metal without the use of any other substance.

Such diffusions and seamless bonds clearly differ from conventional adhesion techniques in which the resin seal is glued to the metal product. In the conventional adhesion technique, the molecules of the resin seal and the metal atoms do not commingle and instead, a sharp and clearly defined boundary remains between the resin seal and the metal after adhesion with glue. In addition to being generally more troublesome to manufacture, such adhesion bonds are more likely to prematurely deteriorate and thus, the seal will prematurely detach from the metal.

In addition, the present metal molded products include products comprising at least two different metals. Preferably, an integrally formed seal is disposed at the boundary between the two different metals. For example, a pre-formed metal part, such as a bolt, may be inserted into metal mold and the seal is temporarily secured within the metal mold at the expected boundary surface between the metal part and the metal molded body. Thereafter, molten metal is introduced into the metal mold and the heat from the molten metal vulcanizes the seal. However, the pre-formed metal part preferably does not melt during the die cast molding operation.

In another preferred aspect of the present teachings, the boundary surface between the metal molded body and the metal part having a different metal composition may have a concave shape.

Various methods for making a metal molded product having an integrally formed rubber or synthetic seal are also taught. For example, an unvulcanized rubber or unhardened resin seal member may be temporarily secured to a metal mold. Then, molten metal is introduced into the metal mold. Heat from the molten metal preferably vulcanizes or hardens said seal member. Further, the molten metal and the seal member preferably form a diffusion or a seamless bond when the two compositions solidify. Thus, the two compositions are commingled in the bond and there are no voids between the resin seal and the metal. In preferred embodiments, thixocasting or thixo molding techniques are utilized. Thixocasting is a method of metal forming that permits metal ingots and components to be shaped in a semisolid state. Vigorous agitation in the early stages of solidification results in a semisolid slurry that flows homogeneously. After solidification, the slurry is reheated for metal forming. Thixo molding is a method of metal forming that permits metal chips to be shaped in a semisolid state. In screw extrusion, metal chips are supplied at one end of a screw that rotates within a cylindrical bore of a temperature-controlled barrel. As the screw rotates, metal chips advance along the barrel. Because of high temperatures and pressures, the metal chips are changed into a semisolid slurry as they travel downstream within the barrel. The semisolid slurry is injected into a mold.

In addition, a metal part having a different metal composition from the molten metal may be disposed within the metal mold before the molten metal is introduced into the metal mold. The unvulcanized rubber or unhardened resin seal member may be temporarily secured within the metal mold at a location that is expected to be the boundary between the two metal compositions and the outside environment. Again, heat generated during die cast molding or thixocasting preferably vulcanizes or hardens the seal member and thereby integrally forms the rubber or synthetic resin seal with the metal molded body. Preferably, a diffusion or seamless bond is formed at the boundary surface between the metal molded body and the metal part having a different metal composition at the outside surface.

Moreover, metal molds are taught that may be utilized to form such metal molded products. These metal molds may include a molding surface having a groove adapted to temporarily secure the unvulcanized rubber or unhardened resin seal member during the die cast operation. In addition, the metal mold may include a molding surface comprising a pressure wall that prevents the injection pressure of the molten metal from being directly applied to the unvulcanized rubber or unhardened resin seal member that is temporarily secured to the metal mold during die cast molding. The pressure wall may be disposed proximally to the groove.

Each of the additional features and method steps disclosed above and below may be utilized separately or in conjunction with other features and method steps to provide improved metal molded products having integrally formed seals and methods for making the same. Detailed representative examples of the present teachings, which examples will be described below, utilize many of these additional features and method steps in conjunction. However, this detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the present teachings in the broadest sense, and are instead taught merely to particularly describe representative and preferred embodiments of the present teachings, which will be explained below in further detail with reference to the figures. Of course, features and steps described in this specification may be combined in ways that are not specifically enumerated in order to obtain other usual and novel embodiments of the present teachings.

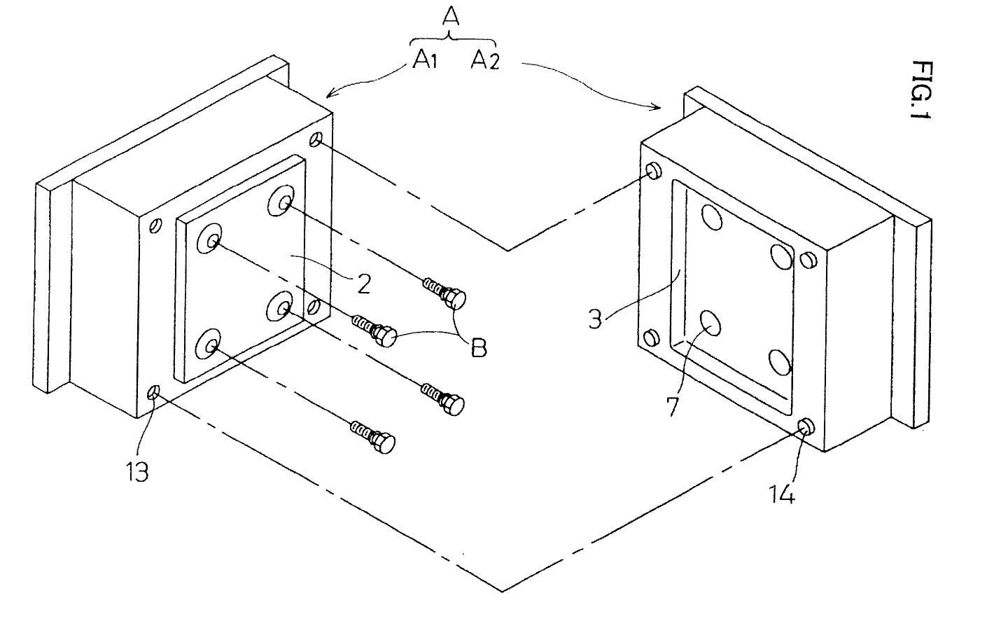

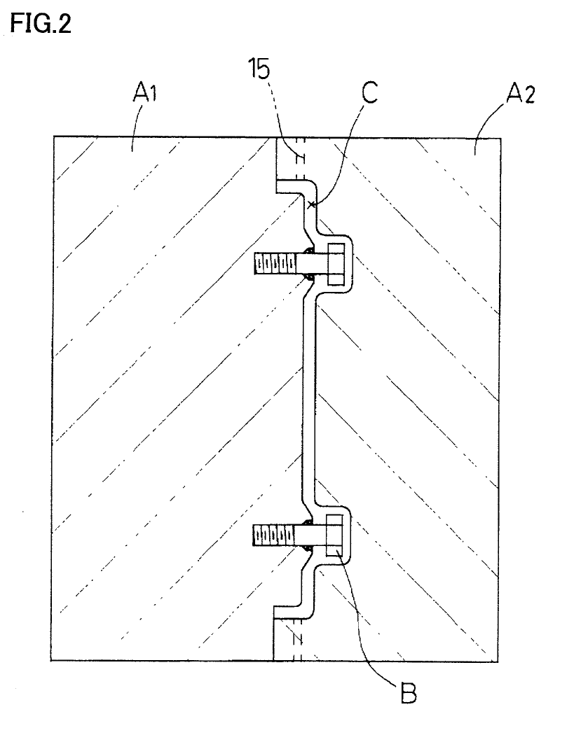

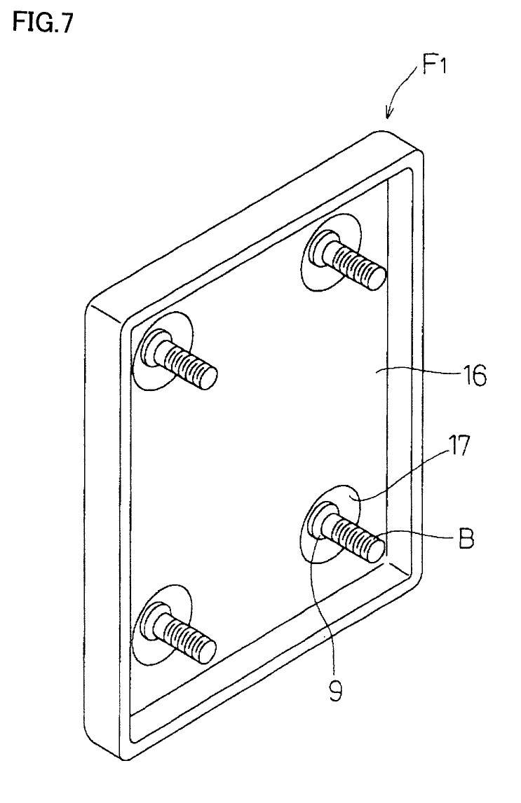

A broken apart, perspective drawing of metal mold A relating to the present teachings is shown in FIG. 1. A vertical cross-sectional diagram showing how the same metal mold is used for molding is shown in FIG. 2. In FIGS. 1 and 2, metal mold A is a mold for forming engine head cover F₁ (see FIG. 7) into which portions of a plurality of bolts B have been inserted, and includes convex mold A₁ and concave mold A₂. The space that is formed when the molds A₁ and A₂ are closed is the molding space (cavity) C. A square molding convex area 2, which corresponds to the head cover F₁, is formed in the center of convex mold A₁ and a square molding concave area 3, which is slightly larger than the molding convex area 2, is formed in concave mold A₂. When the two molds A₁ and A₂ are closed, the molding convex area 2 of the convex mold A₁ is inserted into the molding concave area 3 of the concave mold A₂. Molding space C is thus formed and corresponds to the cross-sectional shape of the aforementioned head cover F₁.

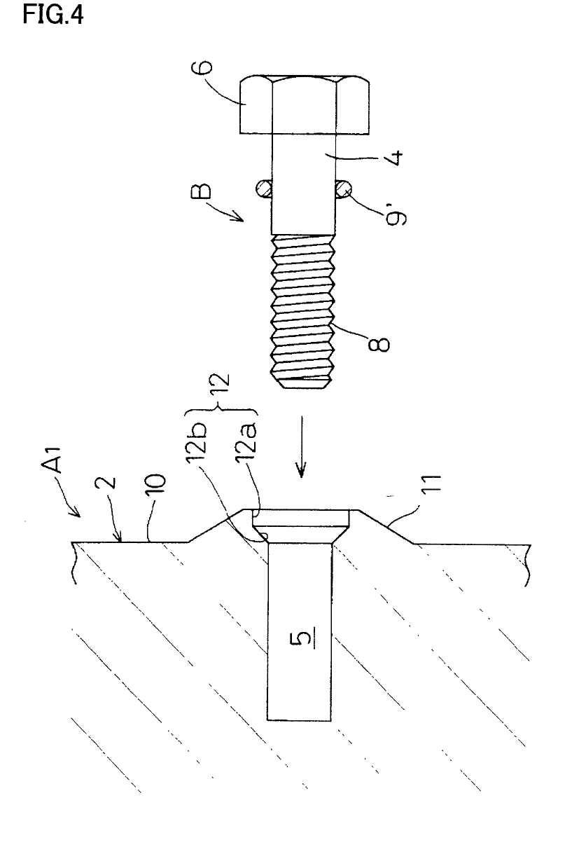

FIG. 4 is a partially magnified cross-sectional diagram of convex mold A₁. Multiple bolt stem insertion holes 5 are adapted to receive stems 4 of bolts B and are formed in the molding convex area 2 of the convex mold A₁. Bolt head insertion holes 7 are adapted to receive heads 6 of bolts B and are formed in portions of molding concave area 3 of the concave mold A₂ that correspond to the bolt stem insertion holes 5. Bolt stem insertion holes 5 formed in the molding convex area 2 of the convex mold A₁ have a depth that completely accommodates the threaded areas 8 of the bolts B. The internal diameter of each bolt stem insertion hole 5 is slightly larger than the outer diameter of the threaded area 8 of the bolt B. Additionally, as will be described below, each bolt B will be inserted into each of the bolt stem insertion holes 5 and a ring-shaped seal member 9′ made of unvulcanized EPDM will be wound on the stem 4. Therefore, the molding convex area 2 of the convex mold A₁ is designed to accommodate the ring-shaped seal member 9′. That is, a pressure wall 11, which has a moderately truncated cone shape, is formed around the external perimeter of bolt stem insertion hole 5 of the molding convex area 2 of the convex mold A₁. This pressure wall 11 is provided to prevent the injection pressure from being directly applied to the seal member 9′, which is disposed at the entrance of the aforementioned bolt stem insertion hole 5, during the injection of molten magnesium. Additionally, the entrance of bolt stem insertion hole 5 formed in the molding convex area 2 of the convex mold A₁ has an internal diameter that is larger than the rest of the area. Therefore, a seal member accommodation hole 12 is formed to accommodate the seal member 9′. The seal member accommodation hole 12 comprises a straight portion 12a that is connected to the molding surface 10 of the convex mold A₁, and a tapered part 12b formed adjacent to the inside of said straight part 12a. As shown in FIGS. 1 and 2, numerals 13 and 14 indicate a press-fitting hole and a press-fitting pin, respectively, provided on convex mold A₁ and concave mold A₂ for alignment. Further, numeral 15 indicates a sprue (runner) that may be adapted to guide molten magnesium into molding space C between closed molds A₁ and A₂.

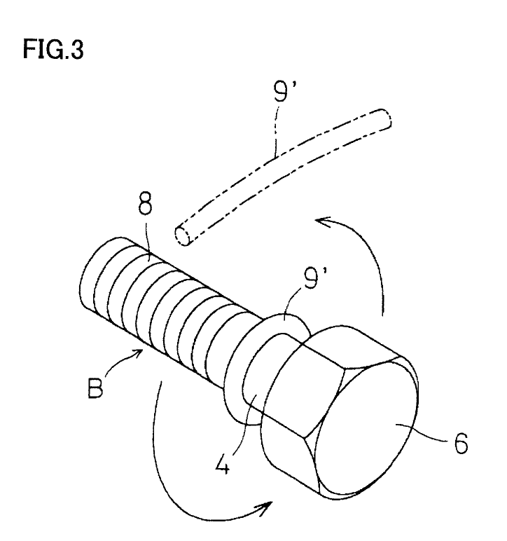

A representative method for forming the aforementioned head cover F₁ using the aforementioned metal mold A will be explained next. First, as shown in FIGS. 3 and 4, a thin rod-shaped seal member 9′ made of unvulcanized EPDM is wound in a ring shape around stem 4 between head 6 and threaded area 8 of steel bolt B. Stem 4 of bolt B has seal member 9′ wound around it and is inserted into bolt stem insertion hole 5 of convex mold A₁. Thus, seal member 9′ is disposed within straight portion 12a of seal member accommodation hole 12, which comprises the entrance of bolt stem insertion hole 5, and is temporarily secured. When stem 4 of each bolt B is inserted into each bolt stem insertion hole 5 of convex mold A₁ in this way, each bolt B is temporarily secured within said convex mold A₁, with a portion of its stem 4 and head 6 protruding from molding surface 10 of convex mold A₁.

In this representative embodiment, the thin rod-shaped seal member 9′ made of unvulcanized EPDM is wound in a ring shape around the stem 4. However, seal member 9′ made of unvulcanized EPDM may be formed in a ring shape beforehand, and the shape of its cross section is not limited to a circular shape and may be rectangular (or square). It is also possible to first temporarily secure seal member 9′ inside seal member accommodation hole 12 of convex mold A₁ and then insert bolt B through the opening of said seal member 9′. Preferably, the tip face of stem 4 of bolt B will contact the bottom surface of bolt stem insertion hole 5 of convex mold A₁.

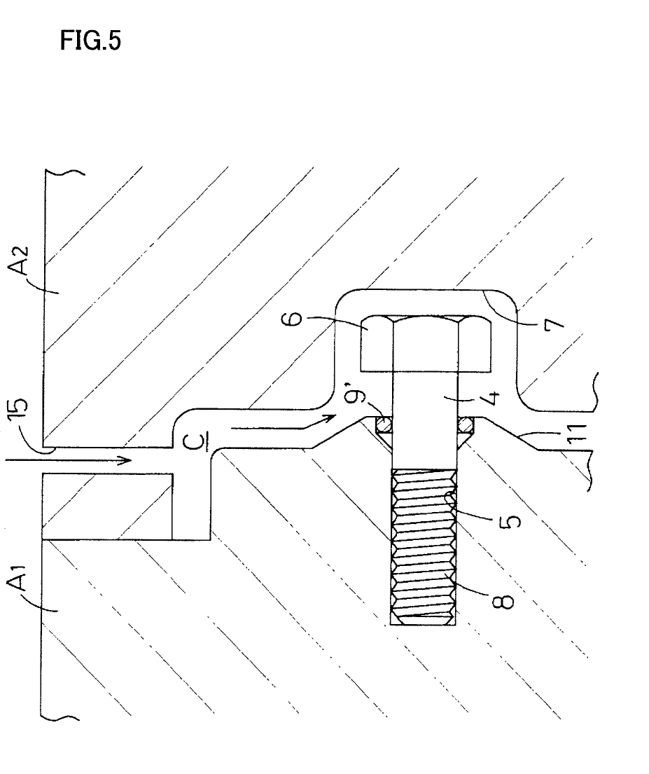

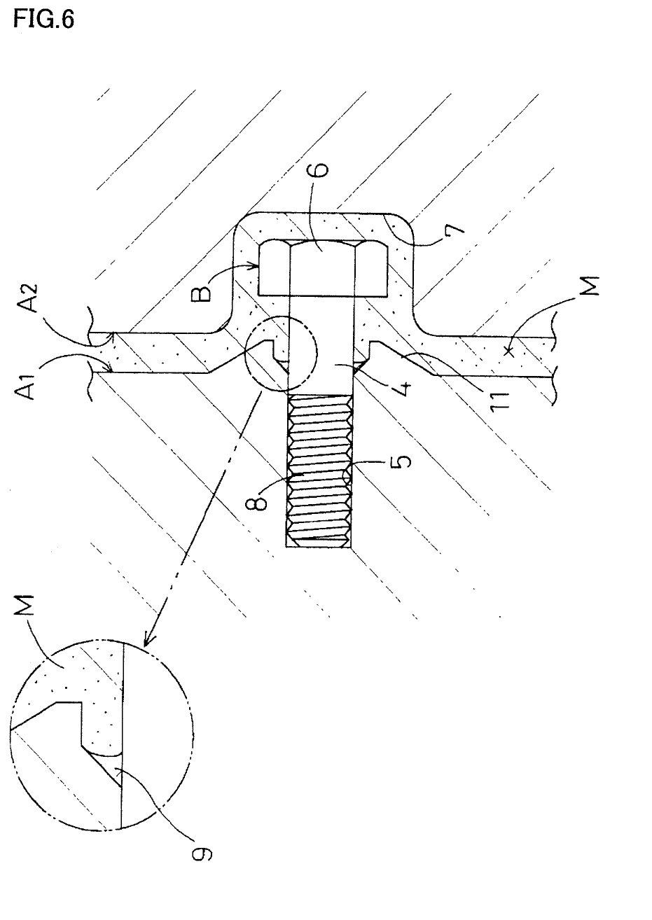

When molds A₁ and A₂ are closed and tightened from the aforementioned state, molding space C is formed between the molding surfaces of molds A₁ and A₂. Further, head 6 of each bolt B is disposed within bolt head insertion hole 7 formed in concave mold A₂, as shown in FIG. 5. Molten magnesium alloy M is then injected through sprue 15 into molding space C between molds A₁ and A₂, and the molten magnesium alloy M fills space C as shown in FIG. 6. The metal may also be injected preferably using thixocasting or thixo molding techniques.

Although not wishing to be bound by theory, a discussion of the behavior (flow) of the molten magnesium alloy M will be provided. The entrance (seal member accommodation hole 12) of bolt stem insertion hole 5 of the convex mold A₁ is provided on the portion of pressure wall 11 that has a moderately truncated cone shape. Further, the seal member 9′ is wound around the stem 4 of bolt B and is temporarily secured inside seal member accommodation hole 12. Thus, the molten magnesium alloy M will flow along the tapered surface of the aforementioned pressure wall 11. Therefore, the injection pressure of the molten magnesium alloy M along the direction perpendicular to the axis of bolt B is not directly applied to the aforementioned seal member 9′. Instead, only the injection pressure of the molten magnesium alloy M along the axial direction of the bolt B is applied to the aforementioned seal member 9′. As a result, the injection pressure in said direction pushes ring-shaped seal member 9′ into tapered area 12b of seal member accommodation hole 12. Therefore, the presence of pressure wall 11 prevents seal member 9′, which has been temporarily secured onto convex mold A₁, from being swept into the flow of the molten magnesium alloy M and the seal member 9′ does not dislodge from stem 4 of bolt B during molding.

The temperature of the molten magnesium alloy M is approximately 590° C. The metal mold A may have a constant temperature of between about 230 and 250° C. and can be used within a range between 150 and 300° C. In addition, the temperature utilized to vulcanize the EPDM may between about 150 and 250° C., and more desirably between 180 and 220° C. Therefore, the seal member 9′ is made of unvulcanized EPDM, will contact both the molten magnesium alloy M and the metal mold A during molding, will be vulcanized by the heat from the surrounding area and will be converted into an elastic vulcanized rubber. Heating also promotes crosslinking of the rubber, thereby increasing its strength. As shown in FIG. 6, seal member 9′ is press-fitted into tapered area 12b of seal member accommodation hole 12 by the injection pressure of the molten magnesium alloy M. At the same time, molten magnesium alloy M fills straight portion 12a of seal member accommodation hole 12. Consequently, the seal member 9′ made of unvulcanized EPDM is vulcanized in the aforementioned state and will become a seal 9 that is integrally formed at the boundary surface between molded body 16 and bolt B. As noted above, seal member 9′ is wound on stem 4 of bolt B and is disposed within seal member accommodation hole 12, which is connected to bolt stem insertion hole 5. Therefore, the molten magnesium alloy M is prevented from entering bolt stem insertion hole 5 during the injection of the molten magnesium alloy M.

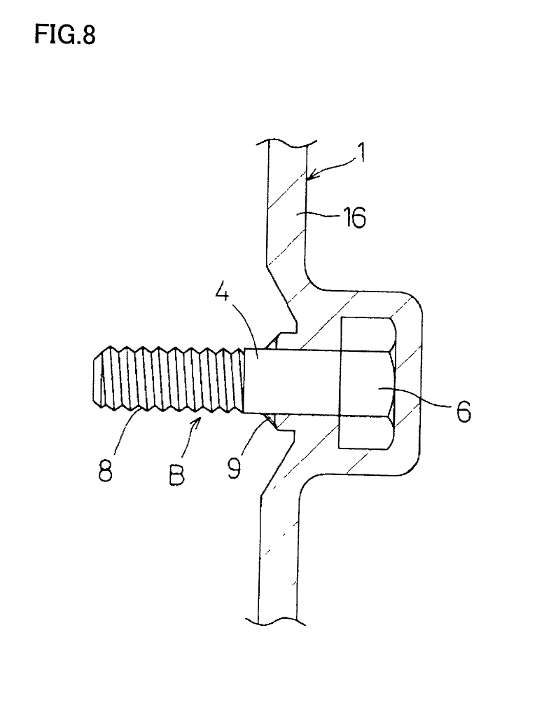

Afterwards, in the same way as known die cast molding methods or known thixo molding methods, molds A₁ and A₂ are separated after metal mold A has cooled for a predetermined amount of time, and the molded product, i.e., the head cover F₁, is removed from the mold. As shown in FIG. 7, a plurality of bolts B are disposed in head cover F₁ and portions of bolts B protrude as stems 4. Circular concave areas 17 correspond to the shapes of pressure walls 11 of convex mold A₁ and are formed at the boundary between the molded body 16 and the bolts B. Additionally, as shown in FIG. 8, seals 9 made of vulcanized EPDM are integrally formed at the boundary between molded body 16 and bolts B. Preferably, the resin seal and the molded body form a diffusion bond, as defined above.

In this representative embodiment, the time between setting seal member 9′ in metal mold A and injecting the molten magnesium alloy M is preferably between several and 60 seconds. The time from the start of the injection of the molten magnesium alloy M to injection completion is preferably between several and 10 seconds. Further, the time from injection completion to molded product extraction is preferably between 10 and 60 seconds.

In addition to unvulcanized EPDM (ethylene-propylene-diene terpolymer or ethylene-propylene rubber), synthetic rubbers such as IIR (butyl rubber (isobutene-isoprene rubber)), CSM (chlorosulfonyl polyethylene), IR (isoprene rubber), BR (butadiene rubber), CR (chloroprene rubber), SBR (styrene-butadiene rubber), NBR (nitrile rubber (acrylonitrile-butadiene rubber)), silicone rubber, acrylic rubber, urethane rubber, and fluoro rubber, as well as blends of these rubbers, may be used as the material for the seal member 9′. In addition to synthetic rubbers, natural rubber may also be used. Furthermore, although the aforementioned embodiment uses unvulcanized EPDM as the material for the seal member 9′, it is also possible to instead use unhardened synthetic resin. If an unhardened synthetic resin is used, the molding heat during molding will thermally harden it. Herein, the term “resin material” includes but is not limited to natural rubber, synthetic resins and rubbers and naturally includes thermo-hardening resins. Use of a rubber containing triazine thiol improves adhesion strength to the metal, and nickel plating applied to the metal markedly improves adhesion strength.

In the metal molded product (head cover F₁) obtained using molding methods according to the present teachings, elastic rubber seals 9 are vulcanized by the molding heat and are integrally formed at the boundary between the molded body 16 and the bolts B. Therefore, rubber seals 9 seal the metal boundary. Consequently, it is difficult for water droplets or other electrolytes to adhere to the boundary between molded body 16 and bolts B. Even if water droplets do adhere, they do not enter molded body 16. Thus, the anti-corrosion properties at the boundary are significantly improved compared to molded products prepared using known molding methods.

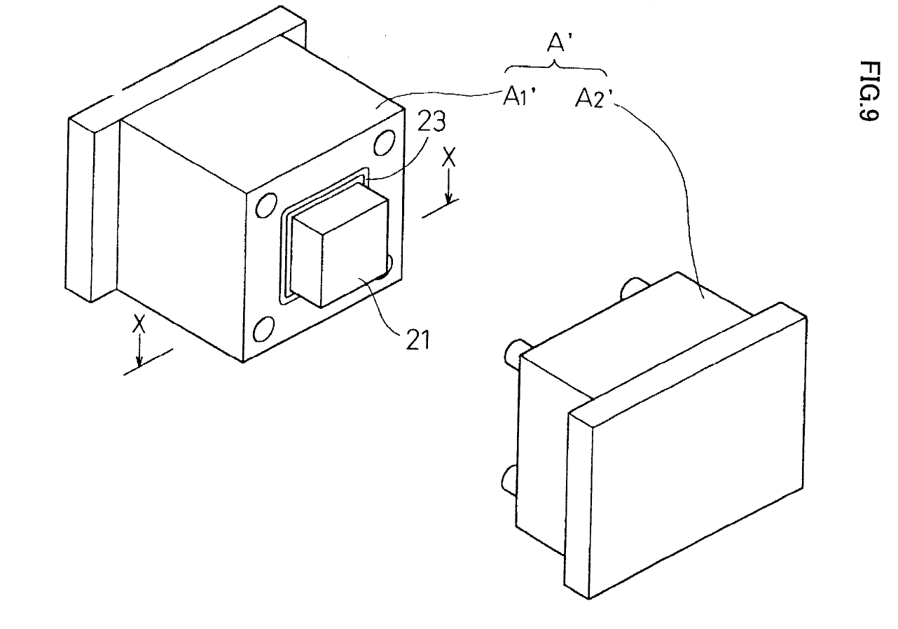

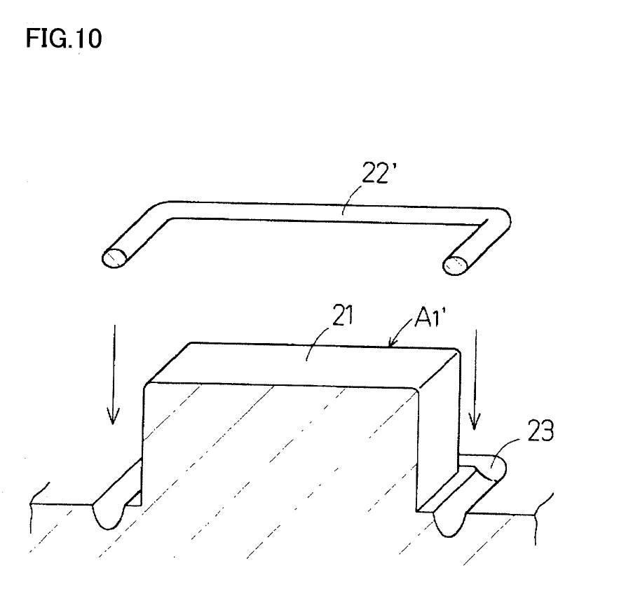

Another representative embodiment of the present teachings will be explained with reference to FIGS. 9 through 13, which show methods for integrally forming a seal 22 on the opening edge of a case F₂ made of a magnesium alloy M using molding methods according to the present teachings. As shown in FIGS. 9 and 10, a metal mold A₁ comprises a convex mold A₁′ and a concave mold A₂′. A square frame-shaped groove 23 is adapted to temporarily securing a seal member 22′ and is formed on the molded surface around a molded convex area 21.

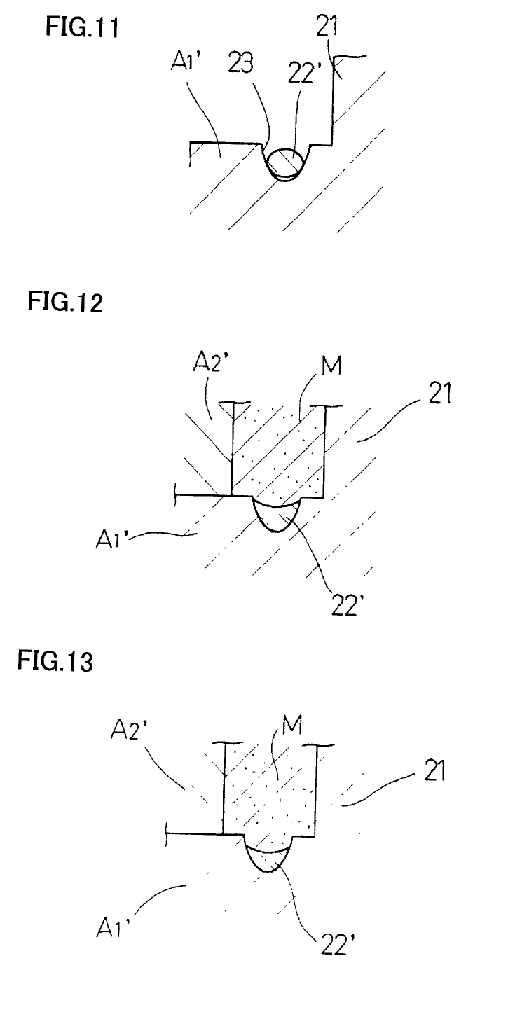

Therefore, as shown in FIG. 11, the square frame-shaped seal member 22′ made of unvulcanized EPDM is press-fitted into groove 23 of convex mold A₁′. Thereafter, the convex mold A₁′ and the concave mold A₂′ are closed and molten magnesium alloy M is injected into the molding space. The injection pressure causes the aforementioned seal member 22′ to tightly adhere to the inside surface of groove 23 as shown in FIGS. 12 and 13. In addition, in the same manner as in the above-described embodiment, the seal member 22′ contacts both the molten magnesium alloy M and the convex mold A₁′ and is vulcanized by the surrounding heat in order to convert it into vulcanized, elastic rubber. As shown in FIG. 14, case F₂ made of the magnesium alloy M is thus formed with elastic rubber seal 22 integrally formed on the opening edge. Preferably, during molding, seal member 22′ made of unvulcanized EPDM is press-fitted into groove 23 provided on the molded surface of convex mold A₁′ and is pressed toward the inside of groove 23 by the injection pressure. Therefore, it will not slip out of groove 23.

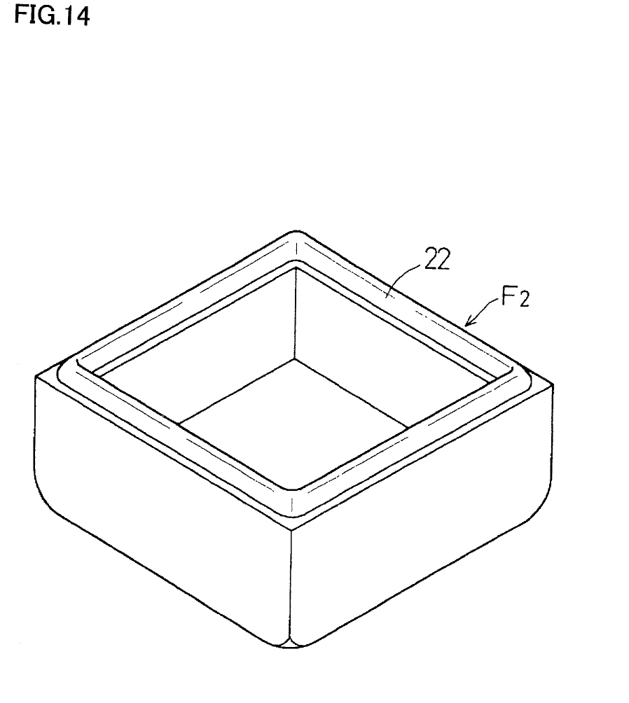

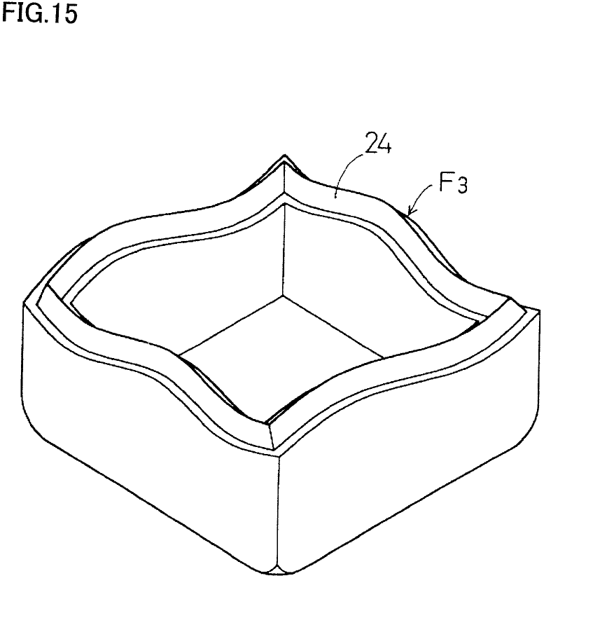

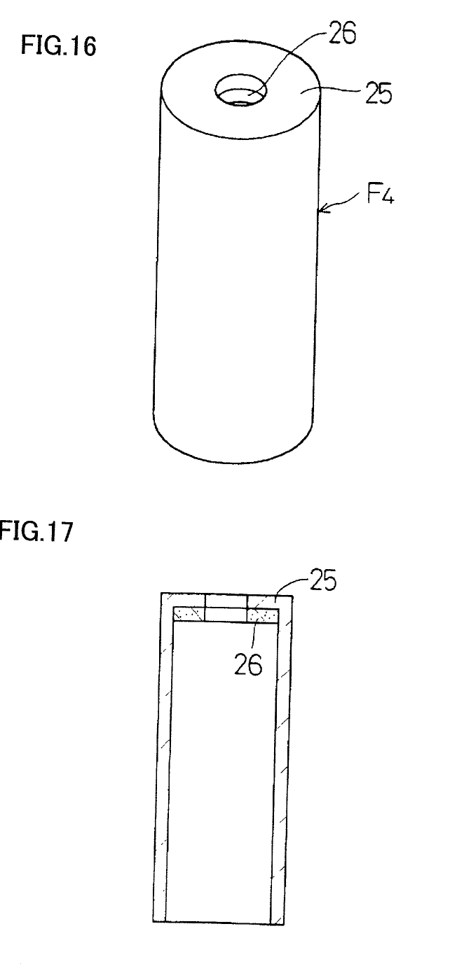

FIGS. 15 through 23 show various molded products F₃ through F₇ that have bodies comprising magnesium alloys. Preferably, rubber seals are integrally formed with the metal bodies using the above-described molding methods. In case F₃ shown in FIG. 15, a seal 24 is integrally formed on the three-dimensionally curved opening edge, and consequently it would be difficult to adhere a separate seal member using an adhesive such as glue. However, the molding method according to the present invention can integrally form seal 24 on the opening edge of case F₃ during molding. The cylindrical molded product F4 shown in FIGS. 16 and 17 has a shape in which a ring 25 is integrally provided on one of the ends of the cylinder. A ring-shaped rubber cushion 26 is integrally formed on the inside of this ring 25. Consequently, it would be difficult to insert a separate cushion 26 into the cylindrical body and glue it. However, the molding methods according to the present teachings can integrally form the rubber cushion 26 during molding of cylindrical molded product F₄.

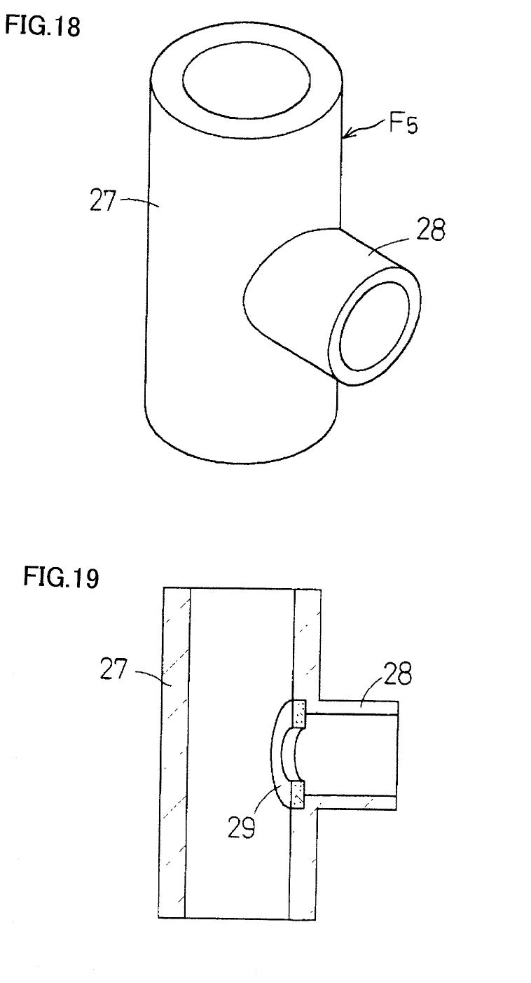

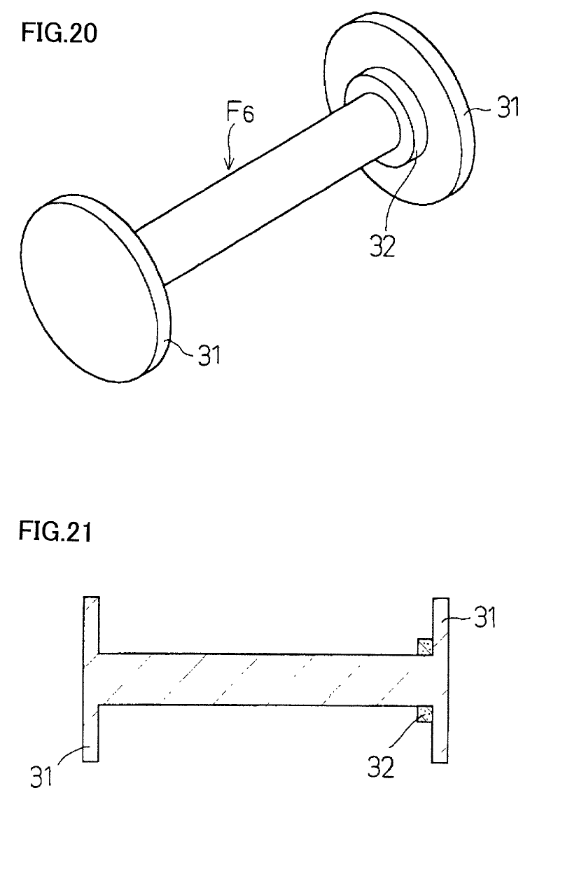

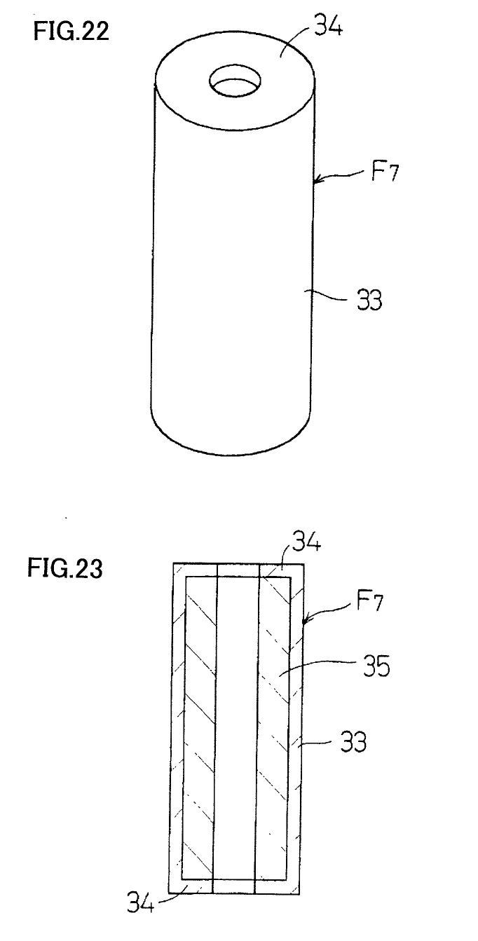

Furthermore, elbow-shaped molded product F₅ shown in FIGS. 18 and 19 has a configuration in which a ring-shaped rubber seal 29 is integrally formed on the internal surface of the area where two kinds of cylinders 27 and 28 cross each other perpendicularly. This molded product can be formed using a pair of split molds and a movable mold that is inserted between the two split molds. In this case, the molded product F₅ can be formed by temporarily securing a ring-shaped seal member in the movable mold and then the body is die cast molded using the two kinds of cylindrical molds. In barbell-shaped molded product F₆ shown in FIGS. 20 and 21, a ring-shaped rubber cushion 32 is integrally formed on the inside of one of platters 31. The cylindrical molded product F₇ shown in FIGS. 22 and 23 has a shape in which rings 34 are integrally provided on both ends of cylinder 33, and a thick-walled cylindrical rubber cushion 35, provided with a central opening having the same diameter as the opening in the rings 34, is integrally formed inside.

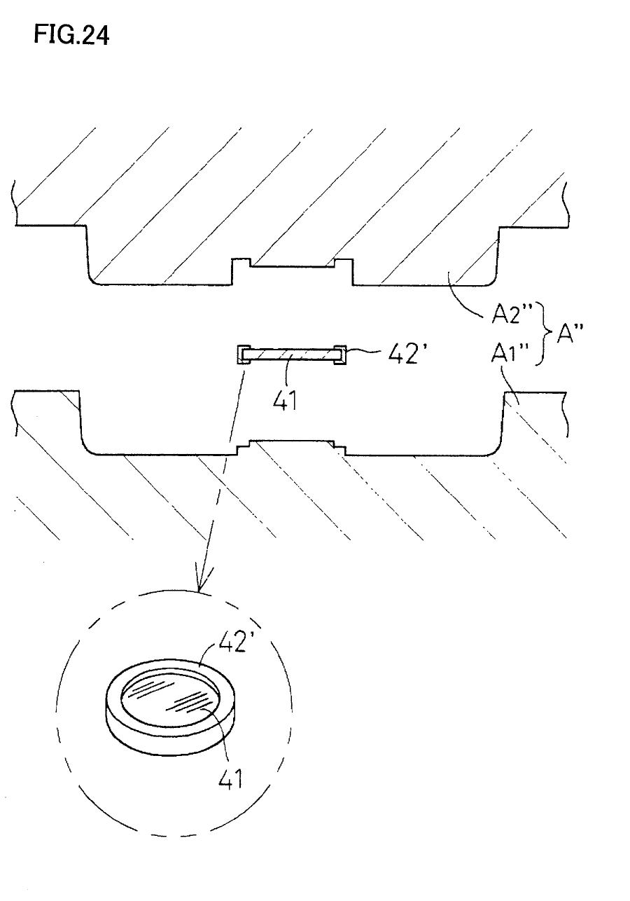

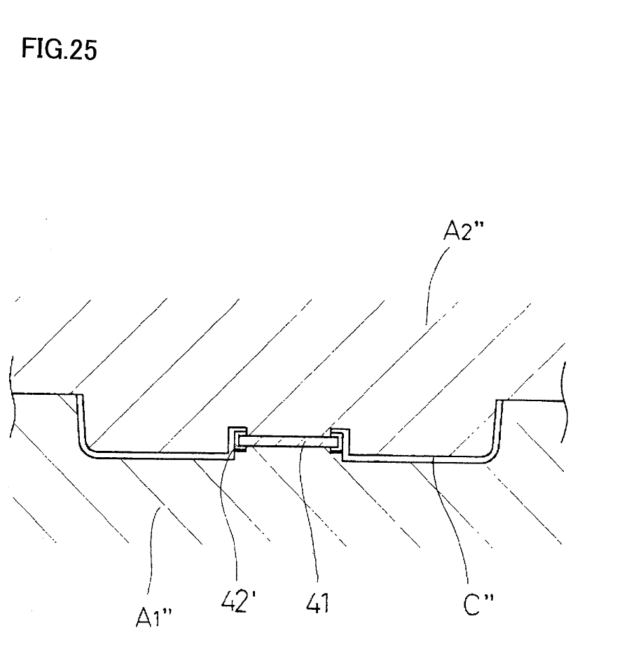

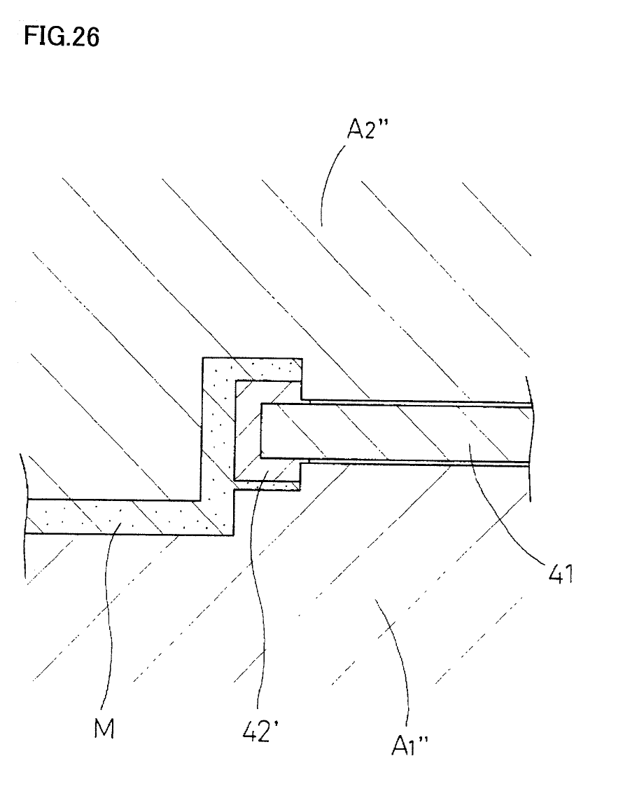

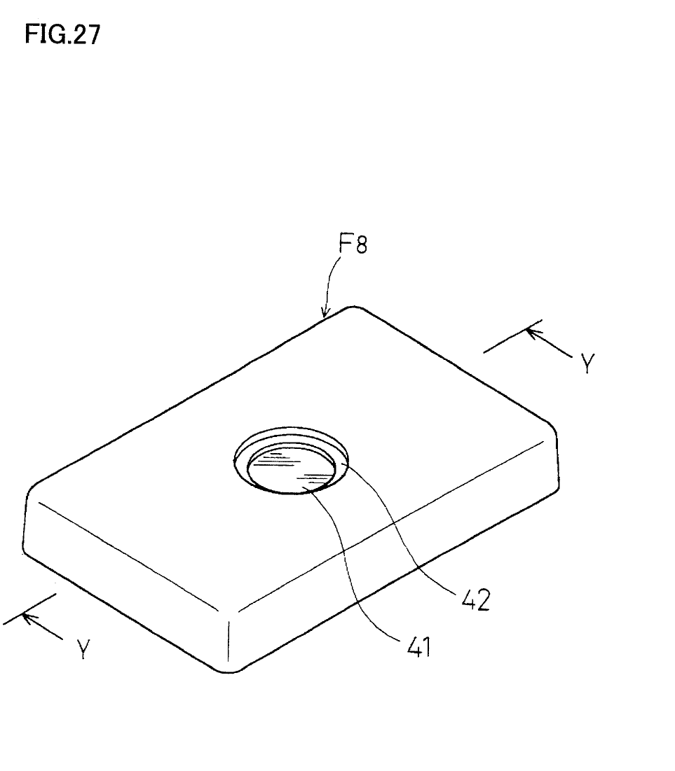

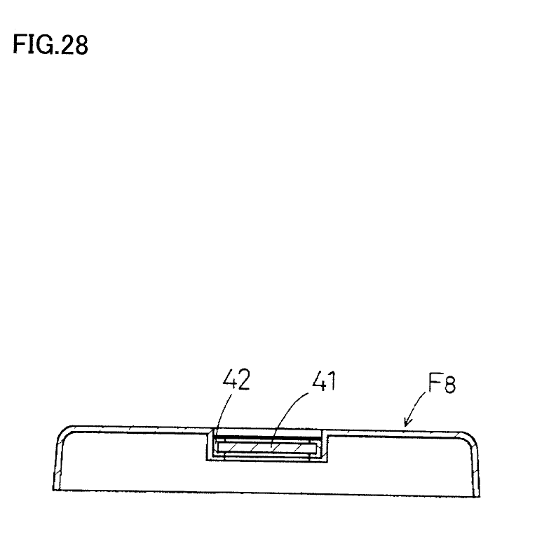

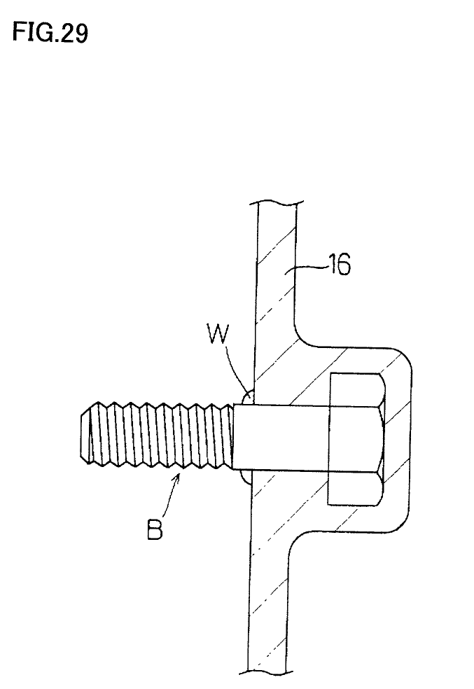

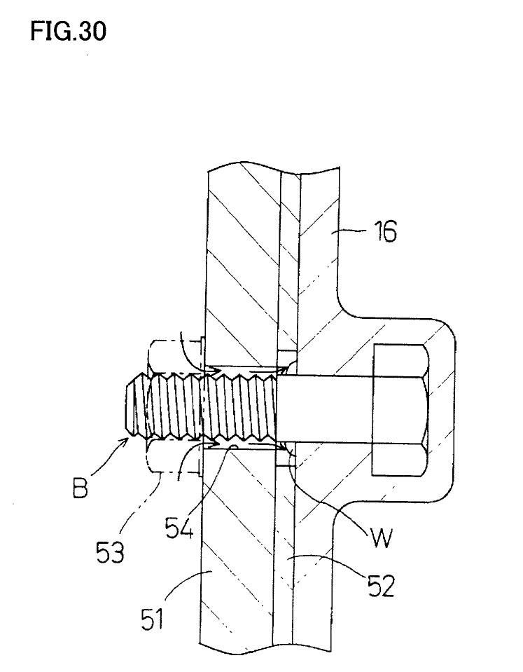

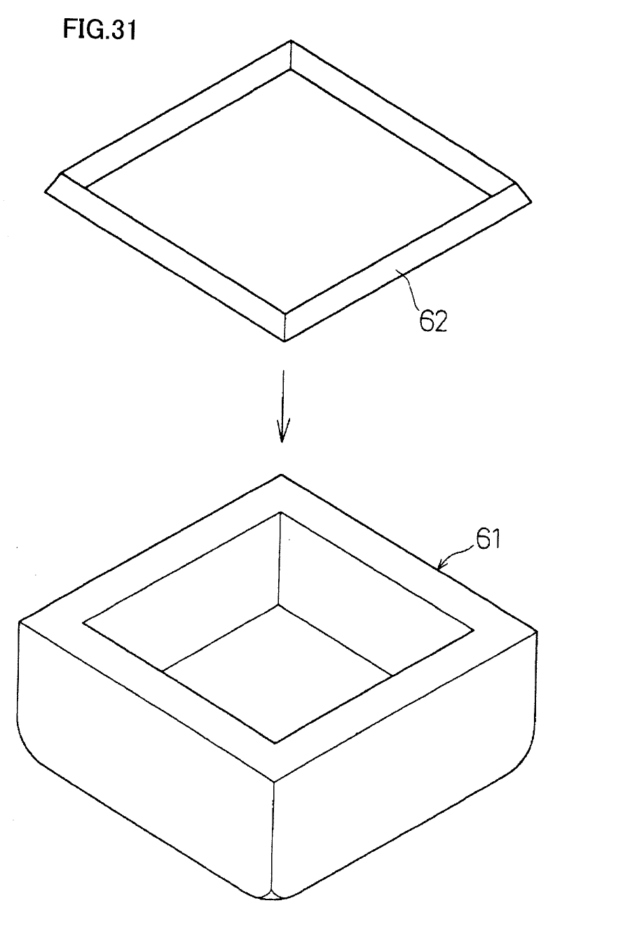

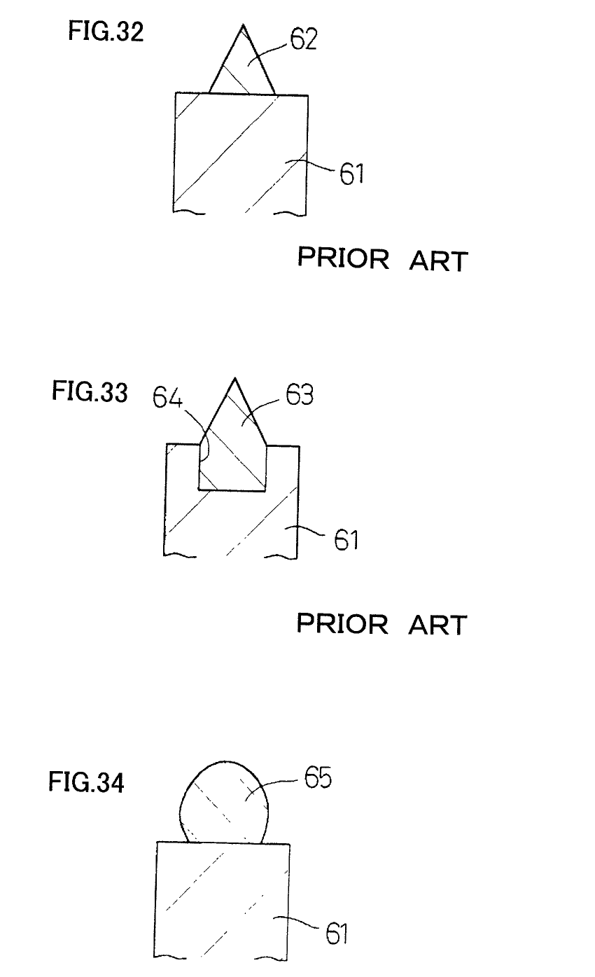

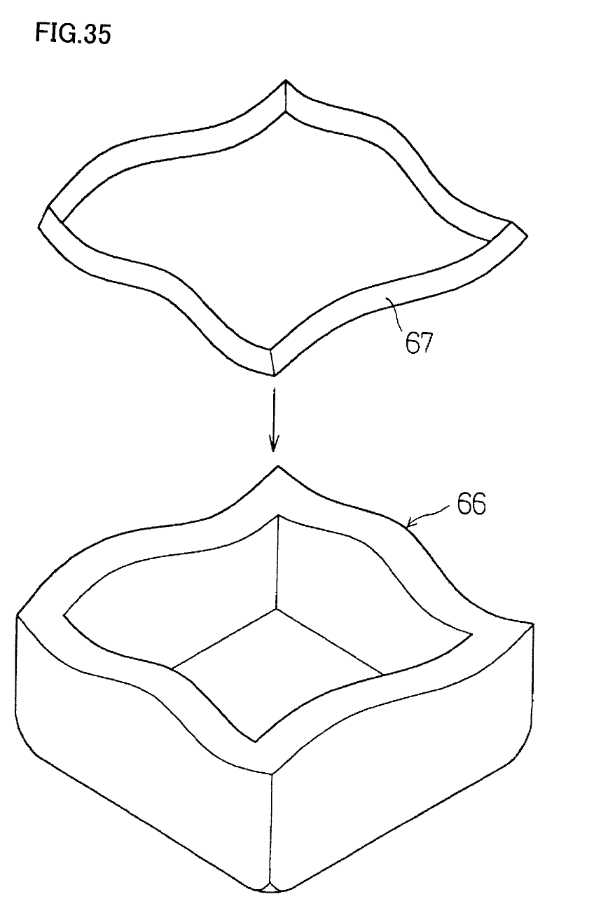

Yet another embodiment of the present invention will be explained with reference to FIGS. 24 through 28. When a glass-integrated molded product F₈ is formed using molding methods according to the present teachings, the product can be formed without having molten metal pressed onto and adhered onto the glass plate area. That is, a ring-shaped seal member 42′ made of unvulcanized EPDM is fitted onto the perimeter of platter-shaped glass plate 41 beforehand. When a molten magnesium alloy M is injected into the molding space C formed between a convex mold A₁″ and a concave mold A₂″ while the aforementioned glass plate 41 is temporarily secured between convex mold A₁″ and concave mold A₂″ of a metal mold A″ as shown in FIG. 24, the presence of seal member 42′ prevents the molten magnesium alloy M from being forced into gaps between glass plate 41 and convex mold A₁″ and concave mold A₂″ (see FIG. 26). This seal member 42′ made of unvulcanized EPDM is vulcanized by the molding heat and is converted into a seal 42 made of elastic rubber (made of vulcanized EPDM). As a result, as shown in FIGS. 27 and 28, it is possible to form glass-integrated molded product F₈ without having the molten magnesium alloy M adhere to the surface of the glass plate 41 at all.

Although the above embodiment is an example in which a glass plate 41 is integrally formed with a metal molded product, other nonmetal bodies can be used instead of a glass body, including a ceramic plate, ferrite and other inorganic materials, etc.

Furthermore, the above-described embodiments describe magnesium alloys, which have extremely low anticorrosion properties, as the metal of the metal molded products, and the present teachings are extremely effective with such magnesium alloys. However, the present teachings can be applied to metal molded products made of other metals, such as but not limited to aluminum alloys. Additionally, although the above-described embodiments describe a bolt as a metal body to be inserted into the metal molded body, this metal body can be selected appropriately based on its relationship with the metal molded product.

1. An apparatus comprising a first metal body and a resin seal, wherein the resin seal is diffusion bonded to the first metal body.

2. An apparatus as in claim 1, further comprising a second metal body comprising a metal composition different from the first metal body, wherein a portion of the second metal body protrudes from the first metal body and the resin seal is disposed at an outer boundary of the first metal body and the second metal body.

3. An apparatus as in claim 2, wherein the boundary surface between the first metal body and the second metal body has a concave shape.

4. An apparatus as in claim 2, wherein the second metal body is a bolt and a threaded portion of the bolt protrudes from the first metal body.

5. An apparatus as in claim 4, wherein the first metal body is an engine head cover, the apparatus comprises a plurality of bolts and resin seals are diffusion bonded to the first metal body at each of the boundary surfaces defined by the bolts and the engine head cover.

6. An apparatus as in claim 5, wherein the resin seal comprises vulcanized EPDM.

7. An apparatus as in claim 1, wherein resin seal is an endless seal adapted to serve as a gasket.

8. An apparatus as in claim 1, wherein the first metal body comprises magnesium.

9. An apparatus as in claim 8, wherein the resin seal comprises a vulcanized resin material selected from the group consisting of ethylene-propylene-diene terpolymer, isobutene-isoprene rubber, chlorosulfonyl polyethylene, isoprene rubber, butadiene rubber, chloroprene rubber, styrene-butadiene rubber, acrylonitrile-butadiene rubber, silicone rubber, acrylic rubber, urethane rubber, and fluoro rubber.

10. An apparatus as in claim 8, wherein the resin seal comprises ethylene-polypropylene-diene terpolymer.

11. An apparatus as in claim 8, wherein the resin seal comprises a synthetic resin.

12. An apparatus as in claim 1, wherein the resin seal comprises a vulcanized resin material selected from the group consisting of ethylene-propylene-diene terpolymer, isobutene-isoprene rubber, chlorosulfonyl polyethylene, isoprene rubber, butadiene rubber, chloroprene rubber, styrene-butadiene rubber, acrylonitrile-butadiene rubber, silicone rubber, acrylic rubber, urethane rubber, and fluoro rubber.

13. An apparatus as in claim 1, wherein the resin seal is vulcanized.

14. An apparatus as in claim 1, further comprising a plurality of bolts having a metal composition different from the first metal body, wherein a threaded portion of each bolt protrudes from the first metal body and resin seals are disposed at an outer boundary of the first metal body and each bolt.

15. An apparatus as in claim 14, wherein the first metal body is a magnesium engine head cover and the resin seals comprise vulcanized EPDM diffusion bonded to the magnesium.

16. A method of making a metal molded product comprising:
disposing a resin material in a metal mold,
introducing molten metal into the metal mold, wherein the molten metal heats the resin material and
cooling the molten metal and the resin material in place such that the resin material integrally forms with the cooled metal.

17. A method as in claim 16, wherein a diffusion bond forms between the resin material and the cooled metal.

18. A method as in claim 17, wherein the resin material is an unvulcanized resin before introduction of the molten metal and becomes a vulcanized resin seal due to the heat of the molten metal.

19. A method as in claim 18, wherein the molten metal is introduced into the metal mold under pressure.

20. A method as in claim 16, further comprising inserting a preformed metal body into the metal mold before introducing the molten metal.

21. A method as in claim 20, wherein the resin material is an unvulcanized rubber or uncured resin seal member that is temporarily secured to a portion of the preformed metal body that will contact the cooled metal product, and a vulcanized or cured seal member is integrally formed at the boundary surface between the pre-formed metal body and the cooled metal.

22. A method as in claim 21, wherein the preformed metal body is a bolt and a plurality of bolts are disposed within the metal mold before introducing the molten metal.

23. A method as in claim 22, wherein the molten metal comprises magnesium and the resin material comprises EPDM.

24. A metal molded product comprising an integrally formed resin seal formed by the process of claim 16.

25. A metal molded product comprising an integrally formed resin seal formed by the process of claim 23.

26. A method as in claim 16, wherein the metal introduction step comprises thixocasting the metal.

27. A mold for making a metal product comprising an integrally formed resin seal comprising:
a first surface having a groove adapted to receive a resin material and
a second surface opposing the first surface, wherein a space between the first surface and second surface defines the metal product.

28. A mold as in claim 27, wherein the first surface further comprises a pressure wall formed adjacent to the groove, wherein the pressure wall prevents injection pressure of a molten metal from being directly applied to the resin material received within the groove.

29. A metal product comprising a metal body and a resin seal, wherein the metal body is adhered to the resin seal by a seamless bond.

30. A metal product as in claim 29, further comprising a pre-formed metal part having a metal composition different from the metal body, wherein a portion of the pre-formed metal part protrudes from the metal body and the resin seal is disposed at an outer boundary of the metal body and the pre-formed metal part.

31. A metal product as in claim 30, wherein the boundary surface between the metal body and the pre-formed metal part has a concave shape.

32. A metal product as in claim 29, wherein the resin seal comprises vulcanized EPDM.

33. A metal product as in claim 29, wherein resin seal is an endless seal adapted to serve as a gasket.

34. A metal product as in claim 29, wherein the resin seal comprises a vulcanized resin material selected from the group consisting of ethylene-propylene-diene terpolymer, isobutene-isoprene rubber, chlorosulfonyl polyethylene, isoprene rubber, butadiene rubber, chloroprene rubber, styrene-butadiene rubber, acrylonitrile-butadiene rubber, silicone rubber, acrylic rubber, urethane rubber, and fluoro rubber.

35. A metal product as in claim 34, wherein the resin seal is vulcanized.
